(19) United States
(12) Patent Application Publication
(10) Pub. No.: US 2002/0171370 A1
(43) Pub. Date: Nov. 21, 2002

(54) String of electrically powered ornaments

(76) Inventor: Geoffrey Harris, Chicago, IL (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/860,677

(22) Filed: May 18, 2001

(51) Int. Cl. H05B 37/00

(52) U.S. Cl. 315/185 R; 315/185 S

(57) ABSTRACT

A string of electrically powered ornaments such as lights connected in a series and sequentially identifiable indicia is applied sequentially in association with each ornament in the string to enable a person to trace the string for testing each ornament.

### FIELD OF THE INVENTION

This invention relates to a string of electrically powered ornaments such as a string of lights used for such purposes as decorating Christmas trees and other symbolic things including commercial branding, showroom displays, etc. More particularly, the invention relates to electrically wired ornament strings and provides means to assist in determining which of the various ornaments in a string has failed. In the following description, the invention is described as it applies particularly to a string of Christmas lights, but it is to be understood that this particular application of the invention is only exemplary of its many uses, and the invention is not to be so narrowly construed except as recited in the appended claims.

### BACKGROUND OF THE INVENTION

Light strings frequently are made with fifty or more lights, and when a light fails generally the others remain lit. Occasionally, however, something happens to a bulb that breaks the electrical circuit and all of the lights in the string go out. When that occurs, it is necessary to check each bulb in the string to find the one that failed. When that light is replaced, the entire string will light. Light testers are available to assist in checking all the lights in a string, but it is often difficult to follow the string when it is wound about the branches of a tree and/or used in close proximity with other strings.

A primary object of the present invention is to provide means to assist a person in tracing a light string so that the bulbs may be tested in order without skipping any of the lights in a string or unknowingly retesting any of them.

Another object of the present invention is to assist a person using a light tester so that it may be used most efficiently.

### SUMMARY OF THE INVENTION

In accordance with the present invention, the string of ornaments, whether they be lights or other electrically powered elements, are sequentially identified by applying indicia to each ornament in the string such as by numbering or lettering each of the ornaments in sequence. This will enable one to sequentially trace the ornaments in a particular string regardless of how the string is displayed or presented so that each ornament in the string may be tested to identify and replace the failed ornament, to reactivate all of the ornaments in the string.

These and other objects and features of the invention will be better understood and appreciated from the following detailed description of selected embodiments thereof, presented for purposes of illustration and shown in the accompanying drawing.

### BRIEF DESCRIPTION OF THE DRAWINGS

FIG. 1 is a perspective view of a typical Christmas tree illustrating how a number of intertwined or interlaced light strings are typically applied to the tree;

FIG. 2 is a diagrammatic view of a string of lights constructed in accordance with the present invention and sequentially numbered to enable the string to be traced even when wound on a tree in the manner generally suggested in FIG. 1 or in any other location;

FIG. 3 is an elevation view of a single light including both a socket and lamp carrying indicia, in this case, a letter, so as to enable a series of such lights to be traced to locate a failed bulb so that it may be replaced and thereby render the entire string operative; and

FIG. 4 is a fragmentary elevation view of a string of lights with indicia applied to tags attached to the wires connecting them in the string.

### DETAILED DESCRIPTION

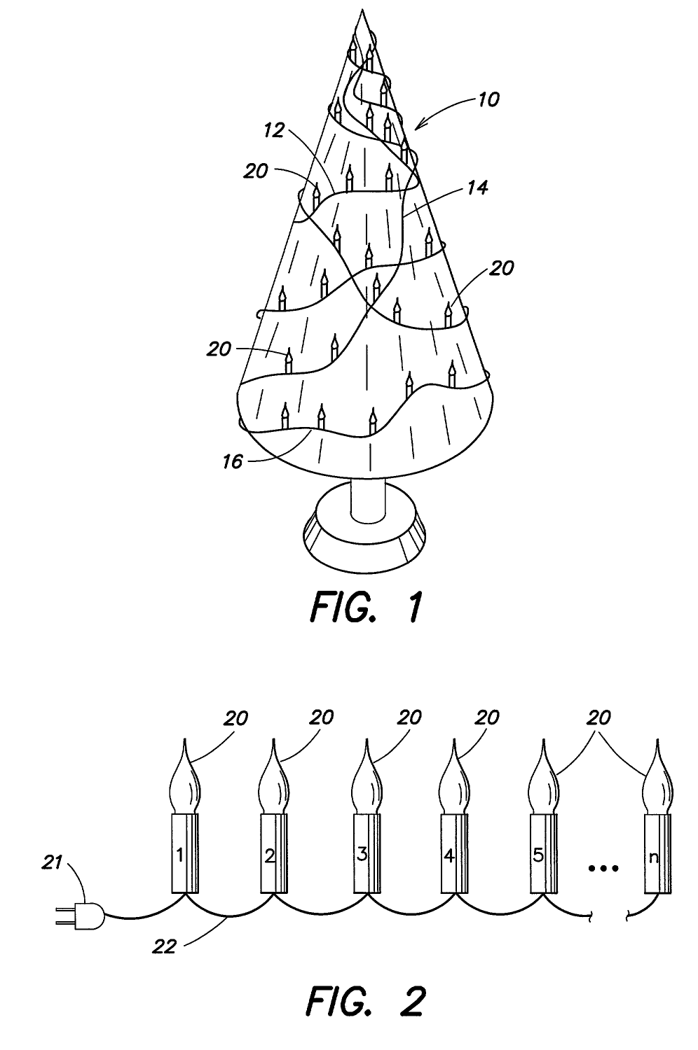

In FIG. 1, a Christmas tree 10 is suggested on which are hung a number of string lights 12, 14, 16, . . . , each composed of a substantial number of ornaments 20. As suggested above, while ordinarily the failure of one bulb will not effect the other lights in a string, occasionally the failure of one will cause the entire string to go dark. The single string, 22 suggested in FIG. 2 includes a plug 21 at one end for connecting the string to a power source. The plug is merely representative of a number of different electrical connectors that may be used. It is not uncommon to have fifty or more lights in a single string, and in large displays a single string may have a very large number, even exceeding 100 or more lights.

It is not difficult to appreciate that when all the lights in a string go dark, it is a difficult and time consuming task to locate the failed bulb that caused it, and this task is made more difficult because of the need to trace the string and test the bulbs in sequence. While various sophisticated circuits have been developed that will indicate where failure has occurred and so as to avoid the necessity for tracing along an entire string, they are expensive and not fully reliable.

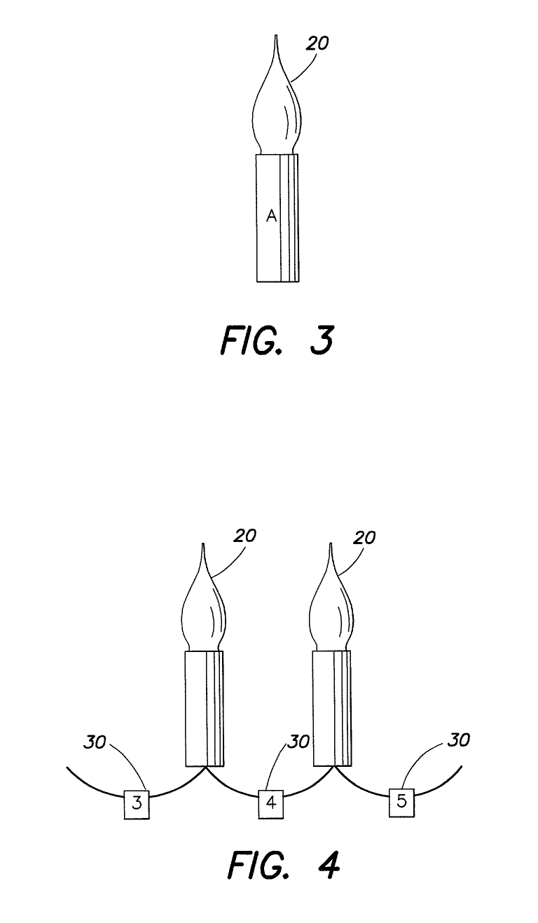

In accordance with the present invention, sequential indicia is associated with each of the lights in a string. Thus, as FIG. 2 suggests ‘n’ lights in the string, they are consecutively numbered 1-“n”. In accordance with one aspect of the invention, the indicia may be applied to the sockets as suggested in FIGS. 2 and 3, but it should be appreciated that the indicia may alternatively be applied to the wiring adjacent each socket by an inconspicuous tag or label 30 wrapped on the wiring as in FIG. 4, or alternatively the wiring itself between adjacent sockets may be sequentially marked so as to assist a person in tracing the string from one end to the other if necessary to locate the failed bulb or other ornament. While in FIG. 2 the indicia is in the form of consecutive numbers applied to the series of lights in sequence, the numbers may be replaced by sequential letters of the alphabet or any other sequential indicia that a person will readily recognize so as to assist him or her to follow the ornaments in series in the string.

While in the foregoing description, the invention has been described as applied to a series of Christmas tree lights in a string, the lights may be replaced by any other electrically powered ornament or device.

While in the foregoing description the lights carry sequential indicia throughout the string, for convenience in manufacturing and to reduce costs, particularly in long strings, an indicia sequence may be repeated. For example in a string of 50 lights, a sequence of 1 through 10 may be repeated five times, or a different sequence may be repeated a sufficient number of times to cover the entire string. In many applications, that arrangement will be adequate to enable a person to trace the string so as to locate the failed light or other ornament.

Having described this invention in detail, those skilled in the art will appreciate that numerous modifications may be made of this invention without departing from its spirit. Therefore, it is not intended that the breadth of the invention be limited to the specific embodiment illustrated and described. Rather, the breadth of the invention should be determined by the appended claims and their equivalents.

What is claimed is:

1. A string of lights comprising
a series of light sockets arranged consecutively in the string,
and sequentially identifiable indicia applied to the sockets for assisting a person working on the string to trace the lights in order in the string.

2. A string of lights as defined in claim 1 wherein the indicia is applied to consecutive sockets in the string.

3. A string of lights as defined in claim 2 wherein the indicia comprises consecutive numbers applied consecutively to the sockets in the string.

4. A string of lights as defined in claim 2 wherein the indicia comprises consecutive letters applied consecutively to the sockets in the string.

5. A string of ornamental lights comprising
a series of lights wired as a string of lights,
and sequentially identifiable indicia operative associated with the lights in the string for assisting a person to trace the string in a chosen sequence with reference to the indicia.

6. A string of ornamental lights as defined in claim 5 wherein the indicia is a series of numbers.

7. A string of ornamental lights as defined in claim 5 wherein the indicia is a series of letters.

8. A plurality of ornaments electrically wired together as a string,
and sequentially identifiable indicia applied to the string with reference to each of the ornaments for identifying the order of the ornaments in the string.

9. The assembly as described in claim 8 wherein the ornaments include sockets and light bulbs.

10. The assembly as described in claim 8 wherein the indicia is a series of consecutive numbers.

11. The assembly as described in claim 8 wherein the indicia is a series of consecutive letters.

12. The assembly as described in claim 8 wherein the indicia is applied to the wire between the ornaments.

13. The assembly as described in claim 8 wherein the indicia is carried on tags attached to the wire between ornaments.

14. The assembly as described in claim 8 wherein the indicia is applied to the ornaments.
